(19) United States
(12) Patent Application Publication
(10) Pub. No.: US 2022/0266266 A1
(43) Pub. Date: Aug. 25, 2022

(54) LIQUID JET DEVICE FOR SKIN CLEANING

(71) Applicant: SEIKO EPSON CORPORATION, TOKYO (JP)

(72) Inventors: Hirokazu SEKINO, Chino-shi (JP); Yasunori ONISHI, Shiojiri-shi (JP); Takeshi SETO, Chofu-shi (JP); Masaki KATO, Matsumoto-shi (JP)

(21) Appl. No.: 17/652,251

(22) Filed: Feb. 23, 2022

(30) Foreign Application Priority Data
Feb. 24, 2021 (JP) 2021-027395

(51) Int. Cl. B05B 1/02; A47K 7/04

(52) U.S. Cl. CPC B05B 1/02; A47K 7/04

(57) ABSTRACT

A liquid jet device for skin cleaning includes a liquid jet nozzle including a nozzle hole, a pressurized liquid supply unit configured to pressurize liquid and supply the liquid to the liquid jet nozzle, and a processor configured to control operation of the pressurized liquid supply unit to cause the liquid jetted from the nozzle hole to fly as droplets formed by splitting a continuous flow, in which a nozzle hole diameter of the nozzle hole is from 0.01 mm to 0.03 mm, and the processor controls a supply pressure of the pressurized liquid supply unit such that a jetting velocity of the liquid jetted from the nozzle hole is from 10 m/s to 60 m/s.

The present application is based on, and claims priority from JP Application Serial Number 2021-027395, filed Feb. 24, 2021, the disclosure of which is hereby incorporated by reference herein in its entirety.

### BACKGROUND

### 1. Technical Field

The present disclosure relates to a liquid jet device for skin cleaning that jets liquid toward a face or other skin at a high pressure and performs cleaning.

### 2. Related Art

An example of this type of liquid jet device for skin cleaning is described in JP 61-103443 A. JP 61-103443 A discloses a skin cleaner in which a cup is provided at a tip portion of a handheld part with an opening facing outward, and that is used by touching skin with a jet unit, that atomizes water that is pumped from a discharge port of a pump and jets the water toward the opening via the inside of the cup.

However, the skin is touched with the skin cleaner of JP 61-103443 A while the jetted water is atomized, thus sufficient pressing force is not obtained, and there is a problem in that it is difficult to effectively clean skin, particularly sebum or dirt from sebaceous glands.

### SUMMARY

In order to solve the problems described above, a liquid jet device for skin cleaning according to the present disclosure is a liquid jet device for skin cleaning that includes a liquid jet nozzle including a nozzle hole, a pressurized liquid supply unit configured to pressurize liquid and supply the liquid to the jet nozzle, and a processor configured to control operation of the pressurized liquid supply unit to cause the liquid jetted from the nozzle hole to fly as droplets formed by splitting a continuous flow, wherein a nozzle hole diameter of the nozzle hole is from 0.01 mm to 0.03 mm, and the processor controls a supply pressure of the pressurized liquid supply unit such that a jetting velocity of the liquid jetted from the nozzle hole is from 10 m/s to 60 m/s.

### BRIEF DESCRIPTION OF THE DRAWINGS

FIG. 1 is an overall schematic view of a liquid jet device for skin cleaning including a liquid jet nozzle of Exemplary Embodiment 1 according to the present disclosure.

FIG. 2 is an enlarged cross-sectional view of a main part of the liquid jet nozzle of Exemplary Embodiment 1.

FIG. 3 is a high-speed photographed image view obtained by photographing a jet state when a nozzle hole diameter is 0.024 mm and a supply pressure of liquid is 0.3 MPa.

FIG. 4 is a high-speed photographed image view obtained by photographing a jet state when a nozzle hole diameter is 0.024 mm and a supply pressure of liquid is 1.3 MPa.

FIG. 5 is an analysis image view obtained by performing image processing of binarization processing to evaluate jetting and droplet characteristics from a high-speed photographed image view of an exemplary jet state photographed in the same manner as in FIG. 3 and the like.

### DESCRIPTION OF EXEMPLARY EMBODIMENTS

Hereinafter, the present disclosure will be schematically described.

In order to solve the problems described above, a first aspect of a liquid jet device for skin cleaning according to the present disclosure is a liquid jet device for skin cleaning that includes a liquid jet nozzle including a nozzle hole, a pressurized liquid supply unit configured to pressurize liquid and supply the liquid to the liquid jet nozzle, and a processor configured to control operation of the pressurized liquid supply unit to cause the liquid jetted from the nozzle hole to fly as droplets formed by splitting a continuous flow, wherein a nozzle hole diameter of the nozzle hole is from 0.01 mm to 0.03 mm, and the processor controls a supply pressure of the pressurized liquid supply unit such that a jetting velocity of the liquid jetted from the nozzle hole is from 10 m/s to 60 m/s.

It has been known that a size of a droplet is approximately 1.88 times a nozzle hole diameter d based on a non-viscous linear theory. When the nozzle hole diameter d of a nozzle hole is set to be from 0.01 mm to 0.03 mm, and the above is calculated, the droplet size is 0.0188 mm to 0.0564 mm. Furthermore, in consideration of some variation in the droplet size due to smoothness of the nozzle hole, environmental conditions, and the like, the droplet size is from approximately 0.02 mm to approximately 0.1 mm, as an average droplet diameter.

Furthermore, when a jetting velocity of the liquid jetted from the nozzle hole is determined to be 10 m/s to 60 m/s, a velocity of the flying droplet will also be determined. The droplet velocity is nearly the same as the jetting velocity, and thus is from 10 m/s to 60 m/s.

Furthermore, there is a relationship that a flow rate (ml/min) of the liquid increases as the jetting velocity of the liquid increases. Therefore, when the jetting velocity of the liquid is determined, the flow rate (ml/min) of the liquid corresponding to the range from 0.01 mm to 0.03 mm of the nozzle hole diameter d is determined, thus, the number (droplets/s) of droplets generated from the continuous flow is also determined. With the jetting velocity from 10 m/s to 60 m/s, the flow rate of the liquid (ml/min) is from approximately 0.05 to 2.3, and a droplet frequency, which is the number of droplets generated per second (droplets/s), is in a range from approximately 10⁴ to approximately 10⁷ droplets.

The numerical value “from approximately 0.05 to approximately 2.3” of the flow rate (ml/min) of the liquid is for a case in which the number of nozzle holes is one. Therefore, when a plurality of the nozzle holes are present, the value is determined by multiplying the numerical value by the number of holes. This also applies to the following description.

The inventors have confirmed that by causing the droplet in the size range to fly at the droplet velocity in the range and hit skin, it is possible to effectively clean the skin as described below.

According to the present aspect, the nozzle hole diameter of the nozzle hole is from 0.01 mm to 0.03 mm, and the processor controls the supply pressure of the pressurized liquid supply unit such that the jetting velocity of the liquid jetted from the nozzle hole is from 10 m/s to 60 m/s.

Accordingly, approximately 10⁴ to approximately 10⁷ droplets are generated per second, and droplets with an average droplet diameter in a range from approximately 0.02 mm to approximately 0.1 mm fly at a velocity from 10 m/s to 60 m/s and then hit the skin one after another, thus the skin can be effectively cleaned. In addition, because the skin is subjected to physical stimulation by droplet collisions at an ultrasonic wave level frequency in this way, improvements in skin conditions (moisturization, elasticity) can be expected.

A liquid jet device for skin cleaning according to a second aspect of the present disclosure is the liquid jet device for skin cleaning according to the first aspect, wherein the droplet frequency, which is the number of droplets generated per second (droplets/s), is in a range from approximately 10⁴ to approximately 10⁷ droplets per second.

According to the present aspect, the droplet frequency, which is the number of droplets generated per second (droplets/s), is in the range from approximately 10⁴ to approximately 10⁷ droplets per second, and thus the effects of the first aspect can be effectively obtained.

A liquid jet device for skin cleaning according to a third aspect of the present disclosure is the liquid jet device for skin cleaning of the first aspect or the second aspect, wherein the processor is capable of adjusting the supply pressure in a range from 0.1 MPa to 1.5 MPa.

According to the present aspect, the processor is capable of adjusting the supply pressure in the range from 0.1 MPa to 1.5 MPa, so it is possible to easily cause the droplet in the size range to fly at the velocity in the range and hit skin.

A liquid jet device for skin cleaning according to a fourth aspect of the present disclosure is the liquid jet device for skin cleaning of any one of the first aspect to the third aspect, wherein the liquid jet nozzle includes a plurality of the nozzle holes.

According to the present aspect, the liquid jet nozzle includes the plurality of nozzle holes, and thus the range of skin cleaning can be increased.

A liquid jet device for skin cleaning according to a fifth aspect of the present disclosure is the liquid jet device for skin cleaning according to any one of the first aspect to the fourth aspect, wherein a viscosity of the liquid is from 0.7 mPa·s to 20 mPa·s.

According to the present aspect, the viscosity of the liquid is from 0.7 mPa·s to 20 mPa·s, so it is possible to reliably cause the droplet in the size range to fly at the velocity within the range and hit skin.

A liquid jet device for skin cleaning according to a sixth aspect of the present disclosure is the liquid jet device for skin cleaning according to the fifth aspect, wherein a surface tension of the liquid is from 20 mN/m to 74 mN/m.

According to the present aspect, the surface tension of the liquid is from 20 mN/m to 74 mN/m, so it is possible to further reliably cause the droplet in the size range to fly at the velocity in the range and hit skin.

A liquid jet device for skin cleaning according to a seventh aspect of the present disclosure is the liquid jet device for skin cleaning of the fifth aspect or the sixth aspect, wherein the liquid is purified water, fragrance distilled water, skin lotion, slightly acidic water, water containing at least one of anti-inflammatory components, or formulated water containing a bactericidal component.

According to the present aspect, a similar effect to that of the first aspect can be effectively obtained.

### Exemplary Embodiment 1

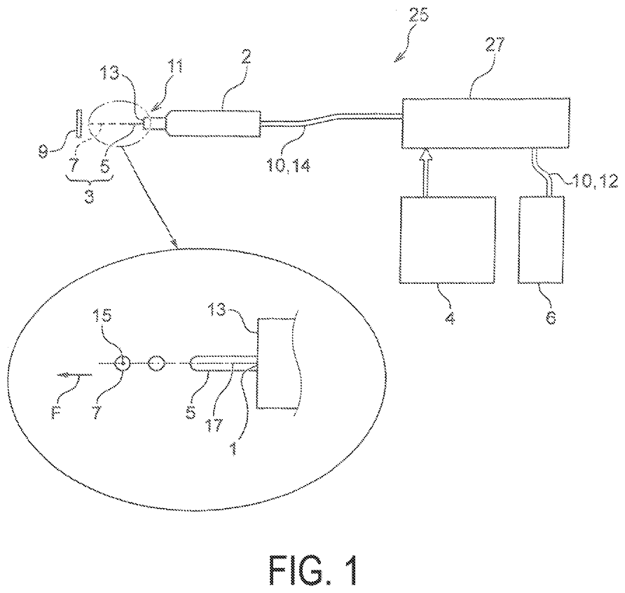

A liquid jet device for skin cleaning of Exemplary Embodiment 1 according to the present disclosure will be described in detail below based on FIG. 1 to FIG. 5. The liquid jet device for skin cleaning can be applied to skin cleaning for the face, arms, hands, feet, back, or the like.

As illustrated in FIG. 1, a liquid jet device for skin cleaning 25 according to the present exemplary embodiment includes a liquid jet nozzle 11 having a nozzle hole 1, a pressurized liquid supply unit 27 configured to pressurize liquid 3 and supply the liquid 3 to the liquid jet nozzle 11, and a processor 4 configured to control operation of the pressurized liquid supply unit 27 to cause the liquid 3 jetted from the nozzle hole 1 to fly as droplets 7 formed by splitting a continuous flow 5.

Specifically, a jet unit 2 having the liquid jet nozzle 11 that jets the liquid 3, a liquid tank 6 that stores the liquid 3 to be jetted, a pump unit 27 that is a pressurized liquid supply unit, a liquid suction tube 12 that forms a flow path 10 of the liquid 3 and that couples the liquid tank 6 and the pump unit 27, and a pump tube 14 that also forms the flow path 10 coupling the pump unit 27 and the jet unit 2 are provided.

Pump operation of the pump unit 27, such as a pressure of the liquid 3 pumped to the jet unit 2 through the pump tube 14 is controlled by the processor 4.

### Liquid Jet Nozzle

In the present exemplary embodiment, the liquid jet nozzle 11 has one nozzle hole 1, and the highly pressurized liquid 3 is jetted from the nozzle hole 1 so as to travel straight. In a partially enlarged view in FIG. 1, a reference sign F denotes a liquid jet direction.

The highly-pressurized liquid 3 jetted from the nozzle hole 1 is the continuous flow 5 immediately after jetting, but is immediately dropletized by surface tension of the liquid 3 to split into a group of the droplets 7. The group of droplets 7 fly in a straight line in the liquid jet direction F. Skin cleaning is performed by causing the flying groups of droplets 7 to hit skin 9 one after another.

Note that, in the partially enlarged view in FIG. 1, in order to facilitate understanding of the illustration, the dimensions of the droplets 7 and the continuous flow 5 are greatly enlarged with respect to other members, and relative dimensional relationships are ignored.

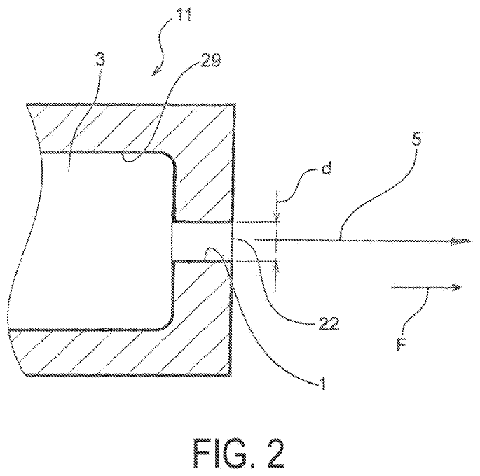

As illustrated in FIG. 2, in the present exemplary embodiment, the liquid jet nozzle 11 has the nozzle hole 1, and a liquid flow path 29 having a diameter greater than that of the nozzle hole 1 and coupled to the nozzle hole 1, and causes the droplet 7 (FIG. 1), generated by dropletizing the continuous flow 5 jetted from the nozzle hole 1, to hit the skin 9. The nozzle hole 1 has a cylindrical shape.

In FIG. 2, a reference sign 22 denotes a jet port. The nozzle hole 1 has a cylindrical shape with a diameter of d, and the jet port 22 has a circular shape with a diameter of d.

In the present exemplary embodiment, the liquid flow path 29 is also formed into a cylindrical shape. Note that, the liquid flow path 29 is not limited to having a cylindrical shape, but may have a polygonal cylindrical shape.

### Nozzle Hole Diameter and Droplet Size

In the present exemplary embodiment, the nozzle hole diameter d of the nozzle hole 1 is created to fall within a range from 0.01 mm to 0.03 mm.

Although a part of the following description may be redundant, it has been known that a size of the droplet 7 (also referred to as a “droplet diameter” hereafter) is approximately 1.88 times the nozzle hole diameter d based on a non-viscous linear theory. When the nozzle hole diameter d of the nozzle hole 1 is set to be from 0.01 mm to 0.03 mm, and the above is calculated, the size of the droplet 7 is 0.0188 mm to 0.0564 mm. Furthermore, in consideration of some variation in the size of the droplet 7 due to smoothness of a hole wall surface 20 of the nozzle hole 1, environmental conditions, and the like, the size of the droplet 7 is from approximately 0.02 mm to approximately 0.1 mm, as an average droplet diameter.

Here, because most of a plurality of the droplets 7 actually are each deformed to be oval or the like rather than be fully spherical, the “average droplet diameter” will be determined as an average value based on a longest diameter part and a shortest diameter part.

### Jetting Pressure, Jetting Velocity

In addition, in the liquid jet device for skin cleaning 25 according to the present exemplary embodiment, the pump unit 27, which is a pressurized liquid supply unit, is configured to supply the liquid 3 at a supply pressure such that a jetting pressure of the liquid 3 jetted from the nozzle hole 1 is from 0.1 MPa to 1.5 MPa.

The processor 4 controls the supply pressure of the pressurized liquid supply unit 27 such that a jetting velocity V of the liquid 3 jetted from the nozzle hole 1 is from 10 m/s to 60 m/s. When the supply pressure is in the range from 0.1 MPa to 1.5 MPa, a state in which the jetting velocity V of the liquid 3 is from 10 m/s to 60 m/s is easily achieved. Note that, since it is sufficient that the jetting velocity V of the liquid 3 is from 10 m/s to 60 m/s, the jetting pressure is not limited to the range from 0.1 MPa to 1.5 MPa.

In the present exemplary embodiment, since the liquid jet device is for skin cleaning, the supply pressure is set in accordance with the nozzle hole diameter d so that the continuous flow 5, jetted at a distance within approximately 10 mm or approximately 20 mm from the jet port 22 of the nozzle hole 1, is split into the droplets 7, that is, the dropletization distance is within approximately 10 mm or within 20 mm.

Note that, a structure that vibrates the continuous flow 5 to be jetted may be provided in the liquid jet nozzle 11, and vibrate the liquid jet nozzle 11, in addition to controlling the supply pressure, to adjust the dropletization distance.

In the present exemplary embodiment, the processor 4 controls the jetting velocity V of the liquid 3 jetted from the nozzle hole 1 to be from 10 m/s to 60 m/s. Specifically, the supply pressure is set in accordance with the nozzle hole diameter d such that the jetting velocity V of the liquid 3 is from 10 m/s to 60 m/s, based on the conditions of the dropletization distance.

When the jetting velocity V is determined to be from 10 m/s to 60 m/s, a velocity S of the flying droplet 7 is also determined. The droplet velocity S is the same as the jetting velocity V until influence of air resistance and the like are exhibited, so the droplet 7 flies at a velocity from approximately 10 m/s to approximately 60 m/s.

Further, when the jetting velocity V of the liquid 3 is determined, a flow rate (ml/min) of the liquid 3 corresponding to the range from 0.01 mm to 0.03 mm of the nozzle hole diameter d is determined, thus, the number of droplets 7 (droplets/s) generated from the continuous flow 5 is also determined. With the jetting velocity V from 10 m/s to 60 m/s, the flow rate of liquid (ml/min) is from approximately 0.05 to approximately 2.3, and the droplet frequency, which is the number of droplets generated per second (droplets/s), is in a range from approximately 10⁴ to approximately 10⁷ droplets per second.

In the present exemplary embodiment, water (mainly purified water) is used as the liquid 3, but fragrance distilled water, skin lotion, slightly acidic water, water containing an anti-inflammatory component, or formulated water containing a bactericidal component may be used.

The viscosity of the liquid 3 is desirably in a range from 0.7 mPa·s to 20 mPa·s, with a liquid temperature in a range from 20° C. to 40° C.

Further, the surface tension of the liquid 3 is desirably in a range from 20 mN/m to 74 mN/m, with a liquid temperature in a range from 20° C. to 40° C.

Note that, the liquid 3 includes a component of Vitamin B2 or B6 that suppresses skin inflammation, an ibuprofen piconol or a glycyrrhizic acid dipotassium component that is an anti-inflammatory component, resorcin that is a bactericidal component, isopropyl methyl phenol and ethanol components.

When the liquid 3 with the viscosity and the surface tension in the respective ranges is used, it is possible to reliably cause the droplet in the size range to fly at the droplet velocity within the range and hit the skin.

### Specific Description

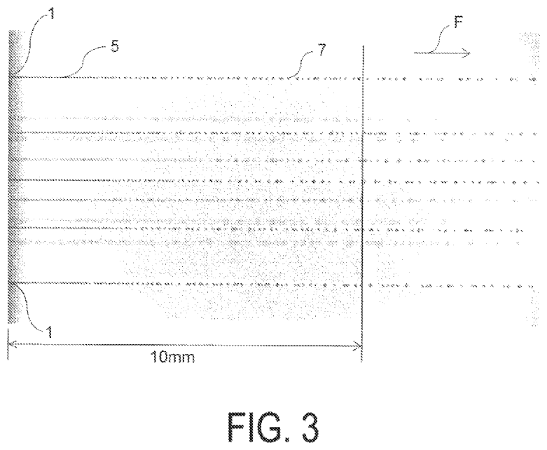

FIG. 3 is a high-speed photographed image view obtained by photographing a jet state, that is flight trajectories of the droplets 7, when the nozzle hole diameter d is 0.024 mm, and a supply pressure of the liquid 3 is 0.3 MPa, using a high-speed camera.

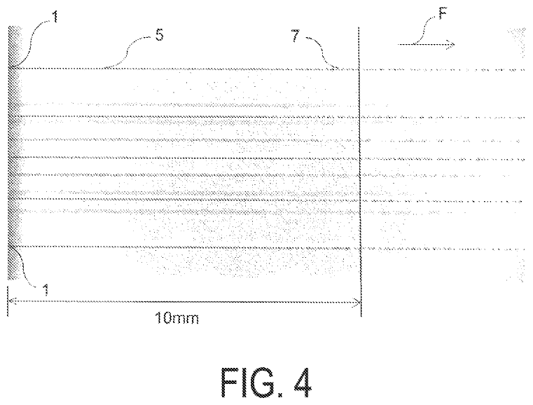

FIG. 4 is a similar high-speed photographed image view of a jet state when the nozzle hole diameter d is 0.024 mm and a supply pressure of the liquid 3 is 1.3 MPa.

In both the cases, it is understood that the dropletization distance is within approximately 10 mm.

Table 1 shows droplet velocities (m/s), droplet diameters (mm), and droplet frequency, which are each the number of droplets generated per second (droplets/s), corresponding to respective supply pressures when the liquid 3 was jetted at five supply pressures (MPa) changed substantially stepwise from 0.2 to 1.1 using the liquid jet nozzle 11 with the nozzle hole diameter d of 0.024 mm. Each numerical value in Table 1 is an analysis value obtained by performing analysis processing on a high-speed photographed image described below. By actually measuring the jetting velocity V of the liquid 3, the droplet velocity (m/s) may be determined to be the same as an actual measured value thereof.

From Table 1, it is understood that the droplet velocities (m/s), the droplet diameters (mm), and the droplet frequency (droplets/s) are all within the range that the present disclosure assumes.

In addition, the right half of Table 1 shows evaluation results corresponding to the respective five supply pressures, when the same liquid jet nozzle 11 was used to actually clean facial skin. EXCELLENT indicates appropriate cleaning can be performed for most people regardless of skin strength, POOR indicates that detergency is higher than EXCELLENT and can be applied to a person having strong skin, and GOOD indicates that detergency is lower than EXCELLENT and is appropriate for a person having weak skin. FAIR has lower detergency than GOOD, and may be used for a person having weak skin, but cleaning efficiency is low.

As can be seen from Table 1, it can be said that skin cleaning can be effectively performed by causing the droplet 7 in the size range to fly at the droplet velocity within the range and hit the skin. It can be said that selecting a supply pressure in accordance with skin strength allows desired cleaning to be performed while maintaining appropriate skin conditions.

TABLE 1
Nozzle hole diameter: 0.024 mm

| Supply | Droplet | Droplet | Droplet | | | | |
|---|---|---|---|---|---|---|---|
| pressure | velocity | diameter | frequency | | | | |
| (MPa) | (m/s) | [mm] | (droplets/s) | Sebum | Make-Up | Corneum | Blackhead |
| 0.2 | 20 | 0.055 | 1.6E+05 | Good | Fair | Fair | Fair |
| 0.4 | 26 | ↑ | 1.8E+05 | Good | Good | Good | Fair |
| 0.6 | 32 | ↑ | 2.5E+05 | Excellent | Good | Good | Good |
| 0.8 | 36 | ↑ | 3.0E+05 | Excellent | Excellent | Excellent | Excellent |
| 1.1 | 41 | ↑ | 3.4E+05 | Poor | Poor | Poor | Poor |

### Method for Determining Analysis Value

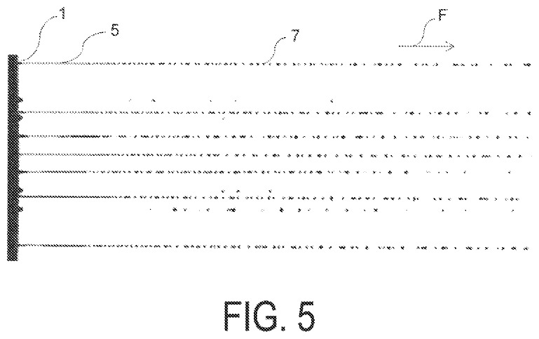

FIG. 5 illustrates an analysis image view obtained by, performing image processing of binarization processing to evaluate jetting and droplet characteristics from a high-speed photographed image view of an exemplary jetting state photographed in the same manner as in FIG. 3 and the like. Free software (ImageJ) was used for the image processing. In the image processing, the photographed image was subjected to the binarization processing, a dropletized range was selected as an analysis region, and the number of droplets in the analysis region, the number of areas of droplets, and center coordinates of each droplet were determined.

Two or three images were selected from images of a high-speed camera that photographed a state in which the continuous flow 5 was completely split into the droplets 7 and the droplets 7 flew, and a distance traveled by the droplets 7 was calculated by comparing the images selected for the focused droplets 7, and this was divided by a photographing time interval to determine the droplet velocity S.

In addition, a dimension (length) of the analysis region was divided by the number of droplets 7 present in the region to determine a distance between the droplets 7 as an average distance, the previously determined droplet velocity S was divided by the average distance between the droplets 7, and the number of droplets 7 generated per second, that is, the droplet frequency (droplets/s) was determined.

In addition, a projected area of each droplet 7 was determined from the number of areas of droplets 7, this was assumed to be a projected area of a spherical body, and a droplet diameter (mm) was determined from diameters of the respective droplets 7 as an average value.

Furthermore, an amount of center axis shift of the entirety of the flying droplets 7 was determined from a difference between maximum and minimum coordinates in a direction orthogonal to the liquid jet direction F being a flying direction of each droplet 7.

The droplet diameter (mm), that is, the size of the droplet 7, with the nozzle hole diameter d of 0.024 mm, was from approximately 0.05 mm to approximately 0.06 mm in the analysis values described above. An average value of the droplet diameters (mm) was 0.055 mm. The average value is more than twice the nozzle hole diameter d, and is consistent with the droplet diameter (mm) being approximately 1.88 times the nozzle hole diameter d based on a non-viscous linear theory.

Furthermore, it was also confirmed that the continuous flow 5 is split into the droplets 7 within 10 mm from the jet port 22 of the liquid nozzle hole 1 from the photographed image. Specifically, the dropletization distance was approximately 3 mm with the supply pressure of 0.3 MPa, and approximately 8 mm with 1.3 MPa.

In addition, regardless of the supply pressure (MPa), the straightness of the flight of the droplet 7 was good, and the maximum value of axial shifts of the center 15 of the droplet 7 with respect to a center axis 17 of the nozzle hole 1 was 0.2 mm. It is understood that the range in which the droplets 7 land has a diameter of less than 0.3 mm (area: less than 0.1 mm²) and is very narrow, and the droplets 7 can be driven even into pores (approximately 0.2 mm to approximately 0.5 mm in diameter), so it is possible to soften and flush lipids or the like accumulated in the pores.

Also, it is understood that the droplet frequency per unit time (droplets/s) increases with increasing droplet velocity (m/s), so more impact effects can be expressed, and more efficient cleaning can be expected.

Table 2 shows droplet velocities (m/s), droplet diameters (mm), and droplet frequency (droplets/s) corresponding to respective supply pressures when the liquid 3 was jetted at five supply pressures (MPa) changed substantially stepwise from 0.2 to 1.5, using the liquid jet nozzle 11 with the nozzle hole diameter d of 0.016 mm. Each numerical value in Table 2 is an analysis value as in Table 1.

From Table 2, it is understood that the droplet velocities (m/s), the droplet diameters (mm), and the droplet frequency (droplets/s) are all within the range that the present disclosure assumes.

Additionally, as can be seen from evaluation results shown in the right half of Table 2, it can be understood that skin cleaning can be effectively performed by causing the droplet 7 in the size range to fly at the droplet velocity within the range and hit the skin.

From Table 2 as well, it is understood that the droplet velocities (m/s), the droplet diameters (mm), and the droplet frequency (droplets/s) are all within the range that the present disclosure assumes.

TABLE 2
Nozzle hole diameter: 0.016 mm

| Supply | Droplet | Droplet | Droplet | | | | |
|---|---|---|---|---|---|---|---|
| pressure | velocity | diameter | frequency | | | | |
| (MPa) | (m/s) | [mm] | (droplets/s) | Sebum | Make-Up | Corneum | Blackhead |
| 0.2 | 20 | 0.038 | 2.3E+05 | Good | Fair | Fair | Fair |
| 0.5 | 29 | ↑ | 3.7E+05 | Good | Good | Good | Fair |
| 0.8 | 35 | ↑ | 4.4E+05 | Excellent | Good | Good | Good |
| 1.2 | 42 | ↑ | 5.5E+05 | Excellent | Excellent | Excellent | Excellent |
| 1.5 | 50 | ↑ | 6.2E+05 | Poor | Poor | Poor | Poor |

### Description of Effects of Exemplary Embodiment 1

(1) According to the present exemplary embodiment, the nozzle hole diameter d of the nozzle hole 1 is from 0.01 mm to 0.03 mm, and the processor 4 controls the supply pressure of the pressurized liquid supply unit 27 such that the jetting velocity V of the liquid 3 jetted from the nozzle hole 1 is from 10 m/s to 60 m/s.

Accordingly, the droplets 7 are generated approximately 10⁴ to approximately 10⁷ droplets per second, the droplets 7 with an average droplet diameter in a range from approximately 0.02 mm to approximately 0.1 mm fly at a velocity from 10 m/s to 60 m/s and then hit the skin 9 one after another, and thus the skin 9 can be effectively cleaned.

### Other Exemplary Embodiments

The liquid jet device for skin cleaning 25 according to the exemplary embodiment of the present disclosure is based on the configuration described above. However, as a matter of course, modifications, omissions, and the like may be made to a partial configuration without departing from the gist of the disclosure of the present application.

(1) When a structure is adopted in which the processor 4 can adjust the supply pressure in a range from 0.1 MPa to 1.5 MPa, by adjusting the supply pressure in the range from 0.1 MPa to 1.5 MPa, it is possible to easily move a droplet in the size range at a velocity in the range and cause the droplet to hit skin.

(2) In the description of the exemplary embodiment described above, the description has been given assuming that the liquid jet nozzle 11 has one nozzle hole 1, however, by adopting a structure in which a plurality of the nozzle holes 1 are provided, the cleaning area can be easily expanded. In this case, the number of nozzle holes 1 is desirably determined based on the nozzle hole diameter d, an appropriate flow rate in use, and a desired supply pressure. For example, when it is desirable that the flow rate of the liquid 3 be suppressed to within 15 ml/min for convenience when collecting and wiping the liquid 3, and the like, and the supply pressure (MPa) can be output up to 1, approximately 20 holes can be provided with the nozzle hole diameter d of 0.024 mm.

In addition, by providing nozzle holes 1 with different nozzle hole diameters, droplets 7 with different droplet diameters can be jetted at the same droplet velocity. The droplet diameter does not affect impact pressure, but as the droplet frequency increases, the kinetic energy increases, thus increasing the force pushing a part against which the droplet collides. As a result, a massage effect can be improved while detergency is maintained.

What is claimed is:

1. A liquid jet device for skin cleaning, comprising:
a liquid jet nozzle including a nozzle hole;
a pressurized liquid supply unit configured to pressurize liquid and supply the liquid to the jet nozzle; and
a processor configured to control operation of the pressurized liquid supply unit to cause the liquid jetted from the nozzle hole to fly as droplets formed by splitting a continuous flow, wherein
a nozzle hole diameter of the nozzle hole is from 0.01 mm to 0.03 mm, and
the processor controls a supply pressure of the pressurized liquid supply unit such that a jetting velocity of the liquid jetted from the nozzle hole is from 10 m/s to 60 m/s.

2. The liquid jet device for skin cleaning according to claim 1, wherein
a droplet frequency that is the number of droplets generated per second (droplets/s) is in a range from 10⁴ to 10⁷ droplets per second.

3. The liquid jet device for skin cleaning according to claim 1, wherein
the processor is configured to adjust the supply pressure in a range from 0.1 MPa to 1.5 MPa.

4. The liquid jet device for skin cleaning according to claim 2, wherein
the processor is configured to adjust the supply pressure in a range from 0.1 MPa to 1.5 MPa.

5. The liquid jet device for skin cleaning according to claim 1, wherein
the liquid jet nozzle includes a plurality of the nozzle holes.

6. The liquid jet device for skin cleaning according to claim 2, wherein
the liquid jet nozzle includes a plurality of the nozzle holes.

7. The liquid jet device for skin cleaning according to claim 3, wherein
the liquid jet nozzle includes a plurality of the nozzle holes.

8. The liquid jet device for skin cleaning according to claim 1, wherein
a viscosity of the liquid is from 0.7 mPa·s to 20 mPa·s.

9. The liquid jet device for skin cleaning according to claim 2, wherein
a viscosity of the liquid is from 0.7 mPa·s to 20 mPa·s.

10. The liquid jet device for skin cleaning according to claim 3, wherein
a viscosity of the liquid is from 0.7 mPa·s to 20 mPa·s.

11. The liquid jet device for skin cleaning according to claim 5, wherein
a viscosity of the liquid is from 0.7 mPa·s to 20 mPa·s.

12. The liquid jet device for skin cleaning according to claim 8, wherein
a surface tension of the liquid is from 20 mN/m to 74 mN/m.

13. The liquid jet device for skin cleaning according to claim 9, wherein
a surface tension of the liquid is from 20 mN/m to 74 mN/m.

14. The liquid jet device for skin cleaning according to claim 10, wherein
a surface tension of the liquid is from 20 mN/m to 74 mN/m.

15. The liquid jet device for skin cleaning according to claim 11, wherein
a surface tension of the liquid is from 20 mN/m to 74 mN/m.

16. The liquid jet device for skin cleaning according to claim 12, wherein
the liquid is purified water, fragrance distilled water, skin lotion, slightly acidic water, water containing at least one of anti-inflammatory components, or formulated water containing a bactericidal component.

17. The liquid jet device for skin cleaning according to claim 13, wherein
the liquid is purified water, fragrance distilled water, skin lotion, slightly acidic water, water containing at least one of anti-inflammatory components, or formulated water containing a bactericidal component.

18. The liquid jet device for skin cleaning according to claim 14, wherein
the liquid is purified water, fragrance distilled water, skin lotion, slightly acidic water, water containing at least one of anti-inflammatory components, or formulated water containing a bactericidal component.

19. The liquid jet device for skin cleaning according to claim 15, wherein
the liquid is purified water, fragrance distilled water, skin lotion, slightly acidic water, water containing at least one of anti-inflammatory components, or formulated water containing a bactericidal component.
